(19) United States
(12) Patent Application Publication
(10) Pub. No.: US 2015/0225270 A1
(43) Pub. Date: Aug. 13, 2015

(54) Dual Flow Septic Vent

(71) Applicant: Jamie Lee Flora, Rocky Mount, NC (US)

(72) Inventor: Jamie Lee Flora, Rocky Mount, NC (US)

(21) Appl. No.: 14/176,061

(22) Filed: Feb. 8, 2014

(51) Int. Cl. C02F 3/30; B09C 1/00

(52) U.S. Cl. CPC C02F 3/30; B09C 1/002; C02F 2203/004; C02F 2203/006; C02F 2303/08; C02F 2209/42

(57) ABSTRACT

A dual flow septic vent is provided for receiving wastewater directed from a septic tank through a flow channel. The dual flow septic vent provides air intake and exhaust ventilation at the transition zone of an anaerobic environment to an aerobic environment. The dual flow septic vent includes an activated carbon filter access cover and a dosing chamber. A flow channel is provide that permits inspections of effluent flow and delivers dosed flows of root control and soil remediation components directly to a targeted site.

### FIELD OF THE INVENTION

The present invention relates to septic vents for allowing air intake and exhaust ventilation into and delivering root control, soil remediation, or other chemical agents to an onsite wastewater management system.

### BACKGROUND OF THE INVEN TION

Septic vents have been used for years on residential and commercial onsite wastewater systems in an effort to exhaust sewer gases exiting from a vertical outlet such as a vent pipe. Usually made of PVC or other non-corrosive material, conventional septic vents commonly come in two variations, one that extends a vent stack above grade and the other, some variation of an ornamental style vent that extends above grade. One of the principle draw backs to conventional septic vents is that their designs do not take into account the need to easily monitor and gain access directly to the drain field. Conventional septic vents may exhaust serer gases, but they do nothing to facilitate dosed amounts of root control or soil remediation components.

Root control is a serious problem especially in the case of onsite wastewater systems that are located near trees. Indeed, the problem is so pronounced that in order to curtail root intrusion, onsite system owners have opted for complete tree removal. In some cases of root intrusion, a complete wastewater system is abandoned and a new system is installed. These approaches to solving the root control problem are very expensive.

Therefore, there is and continues to be a need for a dual flow septic vent that not only dissipates serer gases from onsite wastewater systems, but acts to control root intrusion and allows for correct monitoring of effluent flows.

### SUMMARY OF THE INVENTION

The present invention comprises a dual flow septic vent for receiving wastewater directed from a septic tank through a flow channel and allowing air intake and exhaust ventilation into and delivering root control, soil remediation, or other chemical agents to an onsite wastewater management system. The dual flow septic vent includes a surrounding sidewall structure that accepts the activated carbon filter access cover. A flow channel is provided that facilitates correct monitoring of effluent flows and delivers dose flows of root control and soil remediation components to a targeted site.

Further, the present invention entails a method of monitoring and managing onsite wastewater systems to ensure that the system is working properly as designed. The method entails directing wastewater from a septic tank through a flow channel. Air intake and exhaust ventilation are allowed through an at grade access cover. Root control and soil remediation components are received by the dosing chamber below the flow channel. Effluent that flows through the flow channel mixes with the accumulated components in the dosing chamber and is dispersed according to flow to the final treatment area in the wastewater system.

Other objects and advantages of the present invention will become apparent and obvious from a study of the following description and the accompanying drawings, which are merely illustrative of such invention.

### BRIEF DESCRIPTION OF THE DRAWINGS

FIG. 1 is a perspective view of the dual flow septic vent of the present invention.

FIG. 2 is a cross section view of the dual flow septic vent shown in FIG. 1.

FIG. 3 is a cross sectional view of the flow channel and dose chamber.

FIG. 4 is a top elevational view of the activated carbon filter access cover.

FIG. 5 is a cross sectional view of the activated carbon access filter cover.

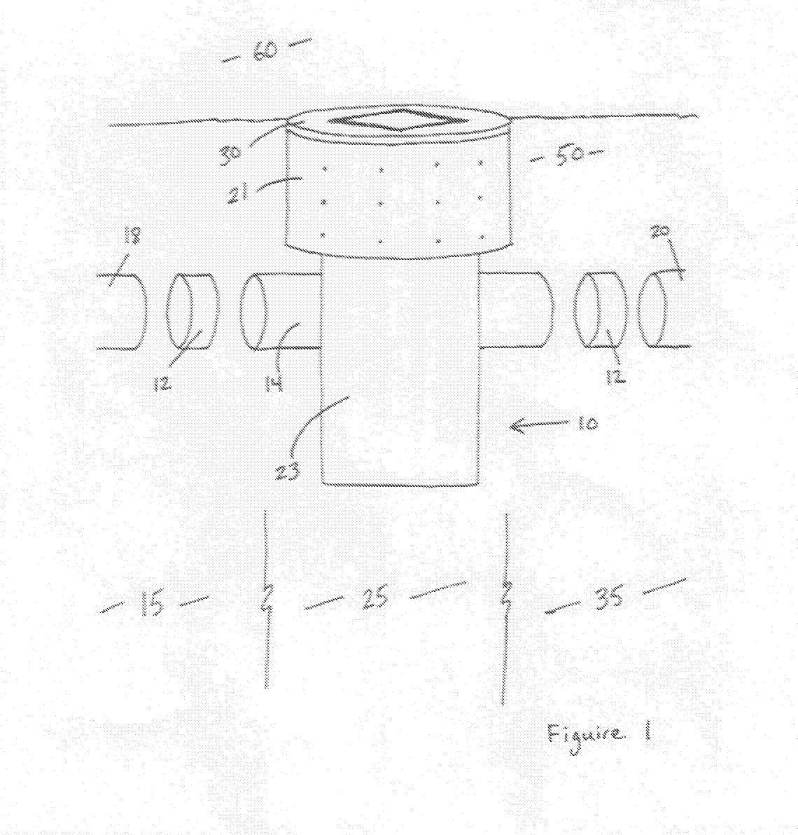

### DESCRIPTION OF THE EXEMPLARY EMBODIMENTS

With further reference to the drawings, the dual flow septic vent of the present invention are shown therein and indicated generally by the numeral 10. As will be appreciated from subsequent portions of this disclosure, septic vent 10 is designed to be located or positioned at the transition zone 25 following an anaerobic environment 15 such as a septic tank 18 or a pressure manifold 18 and preceding an aerobic environment 35 such as a distribution device 20 that disperses effluent flow to a final treatment area. Activated carbon filter access cover 30 is designed to be placed at grade level 60 and septic vent 10 extends into the soil media 50. Flow channel 14 is aligned with an approved connection 12 such that effluent flow is directed through the flow channel 14 and across the dosing chamber 23 for final dispersion to the distribution device 20.

Septic vent 10 includes a surrounding sidewall structure 21. Extending between the sidewall structure 21 is a free access 16 to the septic vent 10. Free access 16 allows for inspections of effluent flow and direct placement of root control and soil remediation components to the dosing chamber 23. Flow channel port 34 allows for air intake, exhaust ventilation, and cross flow through the dosing chamber 23. The lower flow channel port 34A indicates proper effluent flow levels. root control or soil remediation components are contained within the dosing chamber 23 and are slowly released according to effluent flow, it is contemplated that the septic vent 10 would be made watertight and constructed of plastic. Activated carbon filter access cover 30 would be made of plastic and provided with a protective coating to resist UV light. Activated carbon filter access cover 30 facilitates air intake and exhaust ventilation via air holes 44 that are received in a recessed track. Activated carbon filter 55 would be configured in the activated carbon filter cell 41. bottom breather plate 30A terminates the activated carbon filter access cover 30 and holds the activated carbon filter 55 in place. Safety screws 45 secure the activated carbon filter access cover 30 to the sidewall structure 21.

Further, the septic vent 10 would include a fine granular material such as sand. The granular material would be disposed beneath the bottom and would extend upwardly within the surrounding sidewall structure 21. By placing the granular material around the septic vent 10, settling will be reduced and the surrounding sidewall structure 21 can be located uniformly over the septic vent 10.

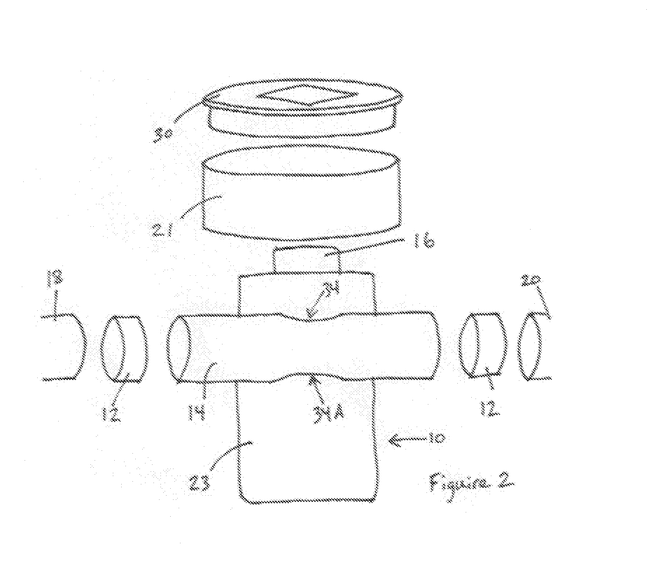

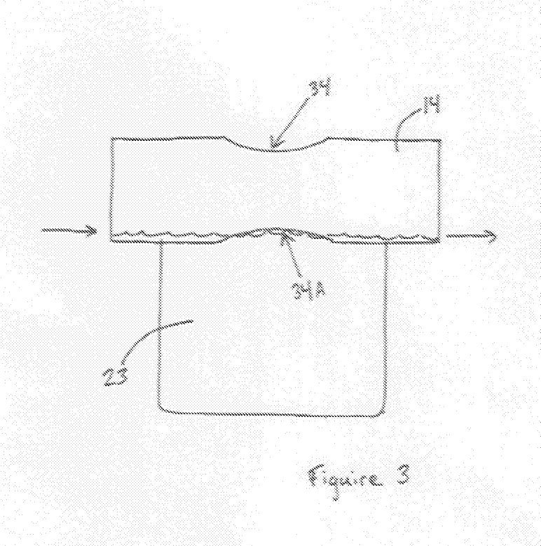

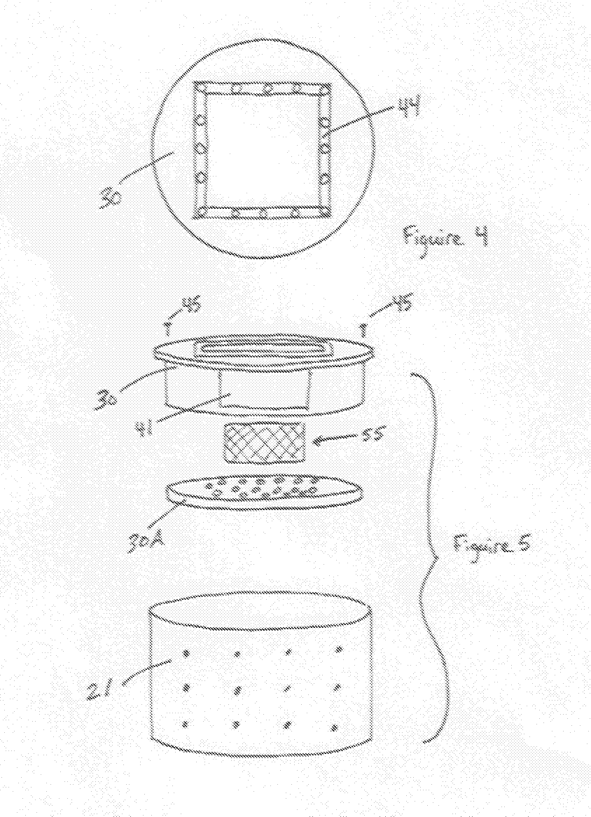

Mixing and dosing occurs at the lower flow channel port 34A. In the case of the design shown in FIGS. 2-3, the flow channel 14 intersects the dosing chamber 23 and as effluent travels across this intersection, products are dispersed for root control or soil remediation. Suspended solids or grease in effluent flows will accumulate settled solids in the dosing chamber 23 that upon inspection will indicate necessary system maintenance that could prevent further system damage.

In the case of septic systems that use an effluent filter or screen, exhaust ventilation is limited after the effluent exits the septic tank 18. The strategic placement of the septic vent 10 in the transition zone 25 reduces hydrogen sulfide (H2S) concentrations that promote corrosion and failure of system components. Air travel is not restricted at the most needed area of the aerobic environment 35.

The principle advantages of the dual flow septic vent 10 of the present invention are that it allows for increased air flow that will reduce the concentration of H2S and help preserve concrete components, ease to gain access for inspection or product application, increased air flow directly at the beginning of the drain field where it is most important, ability to precisely monitor wastewater flow levels, and products can be dose delivered directly to a targeted site. dual flow refers to air flow and dose flow.

The present invention may, of course, be carried out in other ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced there.

1. A dual flow septic vent for allowing air intake and exhaust ventilation into and delivering root control, soil remediation, or other chemical agents to an onsite wastewater management system,
a. a surrounding sidewall structure extending around the septic vent;
b. a flow channel intersecting a dosing chamber for permitting air flow and dose flow;
c. an activated carbon access filter cover at grade;
d. flow channel ports for receiving root control, soil remediation, or other chemical agents;
e. a lower flow channel port for monitoring correct effluent levels;
f. a dosing chamber for dose delivered components in the effluent stream; and
g. a dosing chamber to accumulate solids or grease indicating needed system maintenance.

2. The septic vent of claim 1 wherein the surrounding sidewall structure and the activated carbon filter access cover are disposed at an elevation at grade of the existing surface area.

3. The septic vent of claim 2 wherein the access cover facilitates air intake and exhaust ventilation via air holes that are located in a recessed track.

4. The septic vent of claim 1 including a granular material disposed in the surrounding sidewall structure.

5. An onsite wastewater system comprising:
a. a septic tank;
b. an anaerobic environment;
c. an aerobic environment;
d. an effluent flow;
e. a final treatment area for wastewater effluent; and
f. the septic vent of claim 1 wherein the flow channel is aligned following an anaerobic environment and preceding an aerobic environment.

6. The septic vent of claim 1 wherein the septic vent is round or square.

7. The septic vent of claim 6 wherein the round or square shaped septic vent includes a flow channel wherein effluent flow is directed within a dosing chamber.

8. The septic vent of claim 1 wherein at least a portion of the flow channel includes a bottom and top hole formed in the structure.

9. A dual flow septic vent for delivering root control, soil remediation, or other chemical agents to an onsite wastewater management system,
a. a dosing chamber well for dispersal of root control, soil remediation, or chemical components;
b. a flow channel that intersects the dose chamber;
c. a free access opening in the upper portion of the septic vent; and
d. wherein effluent accumulates in the dosing chamber and moves to the adjacent flow area where the flow channel acts to mix the components applied according to flow volume and disperse the treated flow to the final treatment area.

10. The septic vent of claim 9 further including a surrounding sidewall structure and an activated carbon filter access cover.

11. The septic vent of claim 9 wherein the septic vent assumes a round or square shape configuration, and wherein the flow channel is directed within the dosing chamber.

12. The septic vent of claim 9 wherein at least a portion of the flow channel includes a bottom and top hole formed in the structure.

13. An onsite wastewater system comprising:
a. a septic tank;
b. an anaerobic environment;
c. an aerobic environment;
d. an effluent flow;
e. a final treatment area for wastewater effluent; and
f. the septic vent of claim 9 wherein the flow channel is aligned following an anaerobic environment and preceding an aerobic environment.

14. A method of monitoring and managing onsite wastewater systems to ensure that the system is working properly as designed,
a. direct wastewater through a flow channel;
b. direct air intake and exhaust ventilation within a transition zone;
c. dose deliver components to targeted sites;
d. precisely monitor wastewater flow levels;
e. monitor wastewater qualify and retrieve samples quickly;
f. early identification of system malfunction before polluting nearby water resources and endangering public health.
